(19) United States
(12) Patent Application Publication
(10) Pub. No.: US 2020/0312175 A1
(43) Pub. Date: Oct. 1, 2020

(54) AUTOMATED SYSTEM AND METHOD FOR ADMINISTERING A TEST TO A TEST TAKER USING MULTISTAGE TESTING WITH INTER-SECTIONAL ROUTING

(71) Applicant: Graduate Management Admission Council, Reston, VA (US)

(72) Inventor: Kyungtyek HAN, Chantilly, VA (US)

(21) Appl. No.: 16/371,776

(22) Filed: Apr. 1, 2019

(51) Int. Cl. G09B 7/00

(52) U.S. Cl. CPC G09B 7/00; G06F 16/2282

(57) ABSTRACT

Automated systems and methods are provided for administering a test to a test taker using multistage testing. The test includes a plurality of different test sections, each test section measuring a different quantifiable trait or skill. At least some of the test sections include a plurality of stages, each stage having a test module. Each test module includes a plurality of test items. A first test section is administered that measures a quantifiable trait or skill which is known to correlate with a quantifiable trait or skill that is measured in a second test section. A score is then calculated for the first test section. The second test section is then administered. The second test section measures a different quantifiable trait or skill than the first test section. The second test section has a plurality of stages, wherein the first stage of the second test section is not a routing stage. The first stage of the second test section has a test module that is selected from eligible test modules designated for use in the first stage of the second test section. The test module selection is based on the calculated score of the first test section.

### BACKGROUND OF THE INVENTION

Multistage Testing (MST) is a special type of computerized adaptive testing (CAT), in which the adaptiveness of test form construction happens at the subsection-level instead of at the individual item level. In MST, each subsection of a test is called a “stage”, and each test form/administration consists of multiple stages as the name MST implies. Although MST's measurement efficiency is often not as good as the item-level measurement efficiency of CAT, MST nonetheless is becoming a popular test design in the educational measurement field because of distinct advantages if offers over CAT. For example, MST often offers test developers more control over test construction in terms of possible test forms and content combinations and enables test takers the opportunity to move back and forth among questions within each test stage (Jodoin, Zenisky, & Hambleton, 2006).

In MST, the set of test items to be administered in each stage is called a “module.” Although some new approaches to MST assemble modules for each stage “on-the-fly” (Han & Guo, 2013), in actual applications of MST it is still most common to have multiple modules preassembled for each stage. Test takers are then routed to one of modules in each stage based on their performance in the previous stages. Depending on the purpose of test, MST employs two different strategies for routing modules. The first strategy is based on norm-referenced routing (Armstrong, Jones, Koppel, & Pashley, 2004). In norm-referenced routing, a test taker's expected percentile based on performance in previous stages is compared against the routing cut score(s) from a prior distribution. The other strategy is criterion-based routing. In common practice, criterion-based routing is employed to select the module that has the most relevant difficulty level based on the test-taker's performance in previous stages or that is expected to result in minimal measurement errors.

Criterion-based routing can be accomplished using the item response theory (IRT) framework with information-based targets (Luecht & Nungester, 1998) under the number-correct scoring of classical test theory (CTT), or under the nonparametric adaptive approach such as the tree-based MST. IRT information-based routing is the theoretical and practical equivalent of the maximum Fisher information method for item selection in item-level CAT, arguably one of the most widely used MST routing approaches. The number-correct based routing method is also popular because the routing rule is easier to explain and communicate to test takers. Routing cut scores based on number-correct based routing are still usually derived from the IRT information-based approach. The differences between number-correct routing and IRT information-based routing tend to diminish as the number of items in each stage increases.

In MST applications with preassembled modules with IRT information-based routing, a test taker is always administered a fixed set of test items in the first stage, known as the ‘routing’ stage. Once the routing stage administration is complete, the test taker is routed, in the second stage, to a test module that is expected to result in the maximized Fisher information given the latent trait score, θ, which is estimated based on the items and responses from the routing stage.

Numerous research studies have evaluated the performance and behavior of MST in a variety of different settings especially regarding the number of stages and the number of modules per stage (Armstrong et al., 2004). In theory, the more stages involved in an MST administration, the more adaptive it becomes, resulting in better measurement performance, all things being equal. The greatest number of stages possible in MST would be equal to the number of test items (for fixed-length tests). Although increasing the number of stages in MST tends to improve measurement efficiency due to increased adaptiveness, it undermines the MST benefits compared with CAT. For example, if an MST-based exam with 30 items changes from two stages (with 15 items per stage) to 15 stages (with two items per stage), a test-taker's ability to move back and forth among items within each stage would be less meaningful. In addition, the test developer's process for reviewing and controlling all possible test forms from 15 different stages becomes exponentially more complicated as the number of stages increase. Therefore, determining the best structure and design of MST involves more than simply satisfying a single psychometric aspect (for example, measurement efficiency). Rather, one needs to find and strike the right balance among measurement efficiency, developmental complication, test-taking experience, user communication, and other factors to best serve measurement needs and purposes of the MST program.

Determining the number of modules per stage in MST should follow the same logic. In theory, having more modules available per stage usually helps the overall performance of MST because it is more likely to increase the likelihood of a module that exhibits its maximized Fisher information at the interim θ estimate from the previous stage. Developing a large number (e.g., more than five) of preassembled modules per stage to cover all possible interim θ areas with a higher resolution is not very cost-effective (in terms of overall item utilization), however. It would unnecessarily complicate the MST design and implementation unless the modules were assembled on the fly (Han & Guo, 2013). There is no such thing as a one-size-fits-all deal when it comes to MST design, but, in general, as the previous studies suggest, having a maximum of about four modules per stage constitutes reasonable practice (Armstrong et al., 2004).

Despite the improvements made to date in multistage testing, there is still a need to develop systems and methods that can potentially shorten the test length while retaining the same measurement efficiency as a longer test length. The present invention fulfills such a need.

As discussed below in the framework section, for a short-length test that includes 14 items per section, for example, the testing process of the present invention may provide a greater than 10% reduction in section length.

### BRIEF DESCRIPTION OF THE DRAWINGS

Preferred embodiments of the present invention will now be described by way of example with reference to the accompanying drawings:

FIGS. 1-11 are diagrams and tables illustrating a framework in support of preferred embodiments of the present invention.

FIGS. 12A-12C are flowcharts for implementing preferred embodiments of the present invention.

FIG. 13 is a schematic diagram of a system for implementing preferred embodiments of the present invention.

### SUMMARY OF THE INVENTION

Automated systems and methods are provided for administering a test to a test taker using multistage testing. The test includes a plurality of different test sections, each test section measuring a different quantifiable trait or skill. At least some of the test sections include a plurality of stages, each stage having a test module. Each test module includes a plurality of test items. A first test section is administered that measures a quantifiable trait or skill which is known to correlate with a quantifiable trait or skill that is measured in a second test section. A score is then calculated for the first test section. The second test section is then administered. The second test section measures a different quantifiable trait or skill than the first test section. The second test section has a plurality of stages, wherein the first stage of the second test section is not a routing stage. The first stage of the second test section has a test module that is selected from eligible test modules designated for use in the first stage of the second test section. The test module selection is based on the calculated score of the first test section.

### DETAILED DESCRIPTION OF THE INVENTION

Certain terminology is used herein for convenience only and is not to be taken as a limitation on the present invention.

The words “a” and “an”, as used in the claims and in the corresponding portions of the specification, mean “at least one.”

### I. Definitions

The following definitions are provided to promote understanding of the present invention.

test section—a “test section” as used herein is a portion of a test that measures a specific trait or skill, also referred to herein as “quantifiable traits or skills.” Examples of such traits or skills include quantitative skills and verbal skills. Tests, such as the GMAT® include such test sections, labeled as “Quantitative Reasoning” (quantitative skills) and “Verbal Reasoning” (verbal skills), as well as a test section labeled as “Integrated Reasoning” (IR) that measures ability to analyze data and evaluate information presented in multiple formats. Likewise, the SAT® includes three test sections that measure quantifiable respective traits or skills of Math, Evidence-Based Reading, and Writing.
stage—Each test section includes one or more “stages.” In MST, each stage has a test module. The test taker progresses sequentially through the stages if there is more than one stage. In conventional MST, the test taker's performance (score) in the first stage determines which test module is selected and presented in the subsequent stage. If there are additional stages, the test taker's score on the previous stage, or the cumulative score on the previous stages, is used to determine the test module that is selected and presented in the subsequent stage.
test module—a test module includes a plurality of test items (e.g., test questions). A test module may be preassembled or it may be assembled on-the-fly.
eligible test module—As discussed above, each stage has a test module. As is well-known in the art, individual test modules are designated for use in particular stages of the test section. Thus, there may be a first set of test modules that are eligible for use in the first stage of a particular test section, and a second set of test modules that are eligible for use in other stages of the particular test section. Typically, there is no overlap between the eligible test modules from test stage to test stage. For example, test modules 1-10 may be associated with stage 1, and test modules 11-20 may be associated with stage 2. Thus, the test modules that are “eligible” for selection in stage 1 are the test modules 1-10, and the test modules that are “eligible” for selection in stage 2 are the test modules 11-20.
test section score—Each test section is individually scored. For example, in the GMAT®, the test taker receives an individual score for each of the three test sections (Quantitative Reasoning, Verbal Reasoning, and Integrated Reasoning. The algorithm for scoring a test section depends upon many factors, such as percentage of correct answers, test item difficulty, percentage of test items that were answered or left blank, and the like. Each type of test has its own test scoring algorithm. Test scoring is well-known in the art and thus is not described further.
correlated traits or skills—Test programs that measure cognitive skills commonly include several test sections that measure different quantifiable skills and traits such as quantitative skills and verbal skills. More often than not, those cognitive skills and traits are closely related, so one usually finds moderate to high correlation among the test section scores reflecting each skill or trait. For example, it is typical to observe a correlational coefficient (referred to below as “R”) of 0.50 to 0.70 for math and verbal section scores in many educational test programs. The knowledge about correlational relations between two skills or traits can be used to predict a test score measuring one skill or trait based on an observed test score measuring another skill or trait.

### II. Detailed Disclosure of Preferred Embodiments

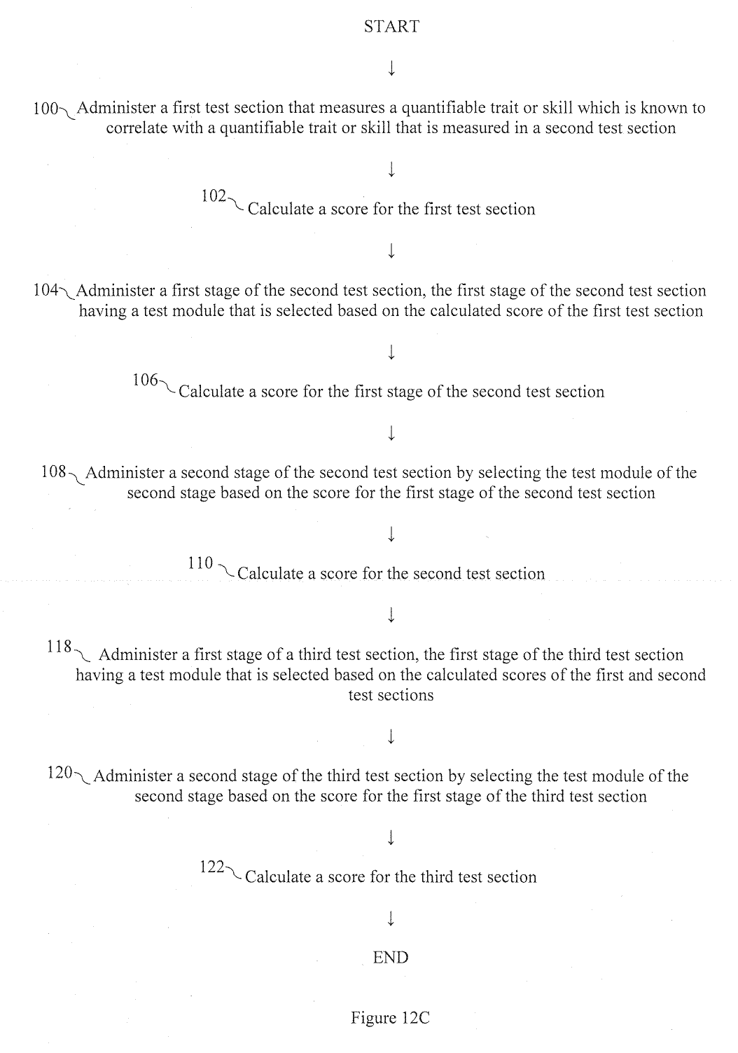

FIG. 12A shows a flowchart of one preferred embodiment of the present invention which provides an automated method for administering a test using multistage testing. Each test includes a plurality of different test sections, and each test section measures a different quantifiable trait or skill. At least some of the test sections include a plurality of stages, each stage having a test module. Each test module includes a plurality of test items.

In the example of FIG. 12A, there are two test sections. The second test section has two stages. In one preferred embodiment, the automated method operates as follows:

STEP 100: Administer a first test section that measures a quantifiable trait or skill which is known to correlate with a quantifiable trait or skill that is measured in a second test section.

STEP 102: Calculate a score for the first test section.

STEP 104: Administer a first stage of the second test section. The second test section measures a different quantifiable trait or skill than the first test section. Unlike conventional MST, the first stage of the second test section is not a routing stage. Instead, the first stage of the second test section has a test module that is selected based on the calculated score of the first test section. The test module for the first stage of the second test section is selected from eligible test modules designated for use in the first stage of the second test section.

STEP 106: Calculate a score for the first stage of the second test section.

STEP 108: Administer a second stage of the second test section by selecting the test module of the second stage based on the score for the first stage of the second test section.

STEP 110: Calculate a score for the second test section.

The first test section may have a plurality of stages, wherein the first stage is a routing stage, as is well-known in the art. If so, the test module for the second stage of the first test section is selected from eligible test modules designated for use in the second stage of the first test section, as is also well-known in the art. Similar rules apply to any subsequent stages. The first section may also have only one stage in which case there is no routing stage in the first section.

The first test section may consist of any suitable set of test items, as long as the score of the first test section measures a quantifiable trait or skill which is known to correlate with a quantifiable trait or skill that is measured in the second test section.

FIG. 12B is an alternative embodiment of FIG. 12A. FIG. 12B is similar to FIG. 12A with respect to steps 100-110. However, it includes a third test section having two stages, and has the following additional steps:

STEP 112: Administer a first stage of the third test section. The third section measures a quantifiable trait or skill which is known to correlate with a quantifiable trait or skill that is measured in the first test section. The third test section measures a different quantifiable trait or skill than the first test section. Unlike conventional MST, the first stage of the third test section is not a routing stage, but instead has a test module that is selected based on the calculated score of the first test section.

STEP 114: Administer a second stage of the third test section by selecting the test module of the second stage based on the score for the first stage of the third test section.

STEP 116: Calculate a score for the third section.

FIG. 12C is another alternative embodiment of FIG. 12A. FIG. 12C is also similar to FIG. 12A with respect to steps 100-110. However, it includes a third test section having two stages, and has the following additional steps:

STEP 118: Administer a first stage of the third test section. The third section measures a quantifiable trait or skill which is known to correlate with a quantifiable trait or skill that is measured in the first and second test sections. The third test section measures a different quantifiable trait or skill than the first and second test sections. Unlike conventional MST, the first stage of the third test section is not a routing stage, but instead has a test module that is selected based on the calculated scores of the first and second test sections.

STEP 120: Administer a second stage of the third test section by selecting the test module of the second stage based on the score for the first stage of the third test section.

STEP 122: Calculate a score for the third section.

The novel MST with inter-sectional routing described herein differs from conventional MST in a very significant way. In conventional MST, second and subsequent test sections each have a routing stage, and the test module of the routing stage is independent of any scoring that occurred in the first or previous test sections, In contrast to conventional MST, in the novel MST with inter-sectional routing described herein, the second test section does not have a routing stage, but instead the test module of the first stage of second section is selected based on the calculated score of the first test section. Likewise, if there is a third or subsequent test sections, these test sections also rely upon the calculated score of selected previous sections for selection of the test module of the first stage of such third or subsequent test sections.

Furthermore, in conventional MST, the first stage has only one test module, whereas in the novel MST with inter-sectional routing described herein the first stage has multiple test modules.

Additionally, in the novel MST with inter-sectional routing described herein, it is necessary that the first test section measures a quantifiable trait or skill which is known to correlate with a quantifiable trait or skill that is measured in a second test section, whereas in conventional MST, the relationship between traits or skills measured in two sections is not considered in test administration and score computation.

The novel MST with inter-sectional routing described herein also differs from conventional CAT in a very significant way. In conventional CAT, when test modules are selected for a test section based on the performance of a previous test section, the test section will always measure the same quantifiable trait or skill as the previous test section. In contrast to conventional CAT, in the novel MST with inter-sectional routing described herein, the test section that has its test module selected based on the performance of a previous test section tests a different quantifiable trait or skill than the previous test section.

In view of the above discussion, it should be clear that the novel MST with inter-sectional routing did not simply adopt testing methodologies from existing MST and CAT testing processes, but instead provides an entirely new paradigm for MST.

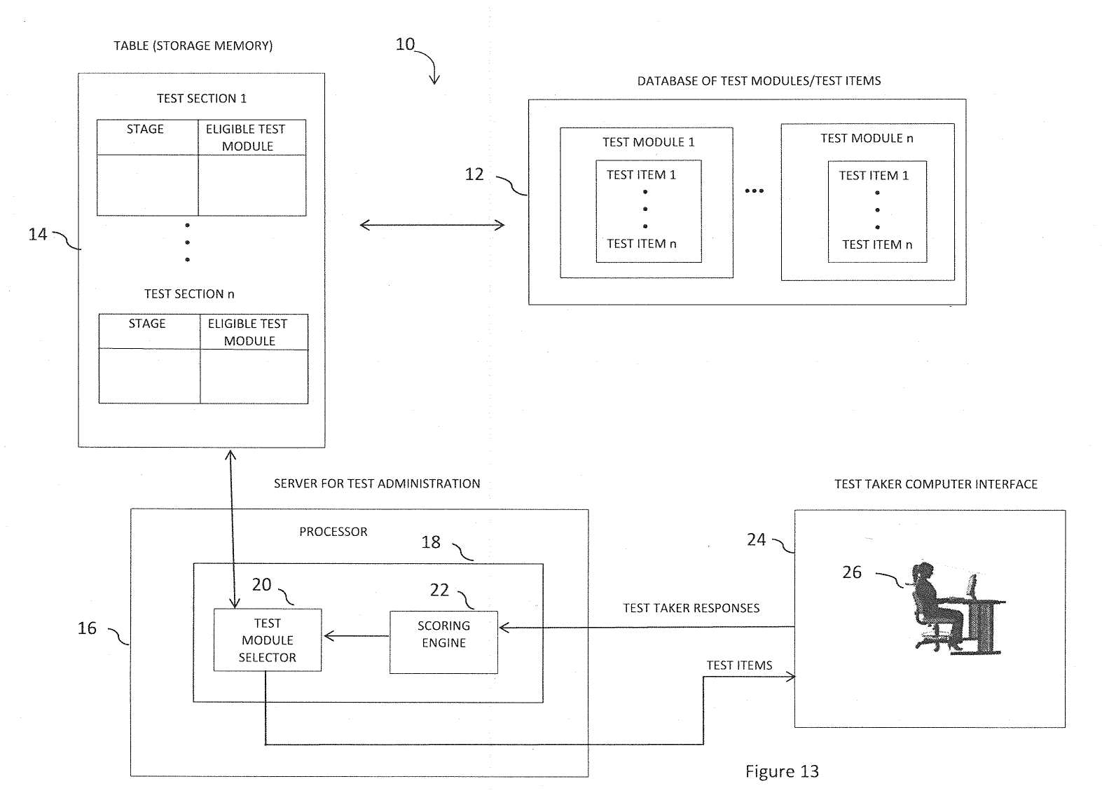

FIG. 13 shows a computer system 10 for administering a test using MST with inter-sectional routing to test takers in accordance with the embodiments of FIGS. 12A-12C. Due to the extensive computations required for administering multistage tests, such tests must be administered by computer.

The computer system 10 includes at least the following elements:

1. database 12 of test modules/test items

2. table 14 (storage memory) that provides a listing of eligible test modules for each stage of different test sections.

3. server 16 for test administration that includes processor 18 having test module selector 20 and scoring engine 22, both of which are software-based.

4. computer interface 24 for test taker 26 (only one computer interface and test taker is shown in FIG. 13).

The present invention may be implemented with any combination of hardware and software. If implemented as a computer-implemented apparatus, the present invention is implemented using means for performing all of the steps and functions described above.

When implemented in software, the software code for the test module selector 20, scoring engine 22 and computer interface 24 can be executed on any suitable processor or collection of processors, whether provided in a single computer or distributed among multiple computers.

The present invention can also be included in an article of manufacture (e.g., one or more non-transitory, tangible computer program products) having, for instance, computer readable storage media. The storage media has computer readable program code stored therein that is encoded with instructions for execution by a processor for providing and facilitating the mechanisms of the present invention. The article of manufacture can be included as part of a computer system or sold separately.

The storage media that is used for the table 14 and the database 12 can be any known media, such as computer memory, one or more floppy discs, compact discs, optical discs, magnetic tapes, flash memories, circuit configurations in Field Programmable Gate Arrays or other semiconductor devices, or other tangible computer storage medium. The storage media can be transportable, such that the program or programs stored thereon can be loaded onto one or more different computers or other processors to implement various aspects of the present invention as discussed above. The storage media may also be implemented via network storage architecture, wherein many devices, which are paired together, are available to a network.

The computer(s) used herein for the processor 18 and the computer interface 24 may be embodied in any of a number of forms, such as a rack-mounted computer, a desktop computer, a laptop computer, or a tablet computer. Additionally, a computer may be embedded in a device not generally regarded as a computer but with suitable processing capabilities, including a Personal Digital Assistant (PDA), a smart phone or any other suitable portable, mobile, or fixed electronic device.

The processor 18 is not general-purpose computers, but instead is specialized computer machines that perform a myriad of test administration functions that are not native to a general-purpose computer, absent the addition of specialized programming.

The database 12, table 14, server 16 and test taker's computer interface 24 may be interconnected by one or more networks in any suitable form, including as a local area network or a wide area network, such as an enterprise network or the Internet. Such networks may be based on any suitable technology and may operate according to any suitable protocol and may include wireless networks, wired networks or fiber optic networks.

The various methods or processes outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

The terms “program” or “software” are used herein in a generic sense to refer to any type of computer code or set of computer-executable instructions that can be employed to program a computer or other processor to implement various aspects of the present invention as discussed above. The computer program need not reside on a single computer or processor, but may be distributed in a modular fashion amongst a number of different computers or processors to implement various aspects of the present invention.

Computer-executable instructions may be in many forms, such as program modules, executed by one or more computers or other devices. Generally, program modules include routines, programs, objects, components, data structures, and the like, that perform particular tasks or implement particular abstract data types. The functionality of the program modules may be combined or distributed as desired in various embodiments.

Data structures may be stored in computer-readable media in any suitable form. For simplicity of illustration, data structures may be shown to have fields that are related through location in the data structure. Such relationships may likewise be achieved by assigning storage for the fields with locations in a computer-readable medium that conveys relationship between the fields. However, any suitable mechanism may be used to establish a relationship between information in fields of a data structure, including through the use of pointers, tags, or other mechanisms that establish relationship between data elements.

### III. Framework for Supporting the Detailed Disclosure of Preferred Embodiments

MST with Inter-Sectional Routing for Short-Length Tests

In theory, the relative improvement of measurement efficiency in adaptive tests over linear tests is most apparent when the test length is short, but in practice, however, the development of an efficient short-length test based on MST poses notable challenges. Test scenarios involving short test lengths, for example, less than 20 items per scale, limit test developers' flexibility in designing MST. The number of stages in this example most likely would not exceed three. In fact, MST with two stages is a common design, even for longer test programs such as the Graduate Record Examination (GRE), or the revised General Test and Comprehensive Testing Program 4 (CTP4) for K-12 students. With only two stages, assuming the number of items per stage is the same across stages, a test based on MST essentially becomes half adaptive because, in typical MST designs, the items in the first (routing) stage are always fixed (nonadaptively selected and administered).

If the routing stage (with a single module for everyone) was skipped and the test module was adaptively selected from the first stage of MST, then the test's level of adaptiveness would be greatly improved—for example, from 50% to 100% in the case of a two-stage MST—and the test's measurement efficiency would increase. The question then becomes: On what basis can routing be started when no item of the test section has been administered to a test taker?

Some ideas that have been discussed for item selection in CAT at the beginning of a test include the possibility of using available collateral information—for example, scores from previous test administrations, scores from other test programs measuring similar skills, usage data from learning systems, and response time data (Thompson & Weiss, 2011). Technically, it's not unreasonable to consider using such collateral information for initial routing in MST to eliminate a linear routing stage, and it might be a sound solution, indeed, for low-stakes exams such as formative assessments. For test programs with high-stake consequences, however, using collateral information for initial routing in MST may be impossible and/or inappropriate because (1) the availability and/or quality of collateral information is often not equal across all test takers, and (2) test routing influenced by external information outside a test can be legally and politically challenged in terms of test fairness. The next question thus becomes: How does one identify collateral information that is (1) available for all test takers, (2) generated from within the test, and (3) appropriate for initial routing in MST?

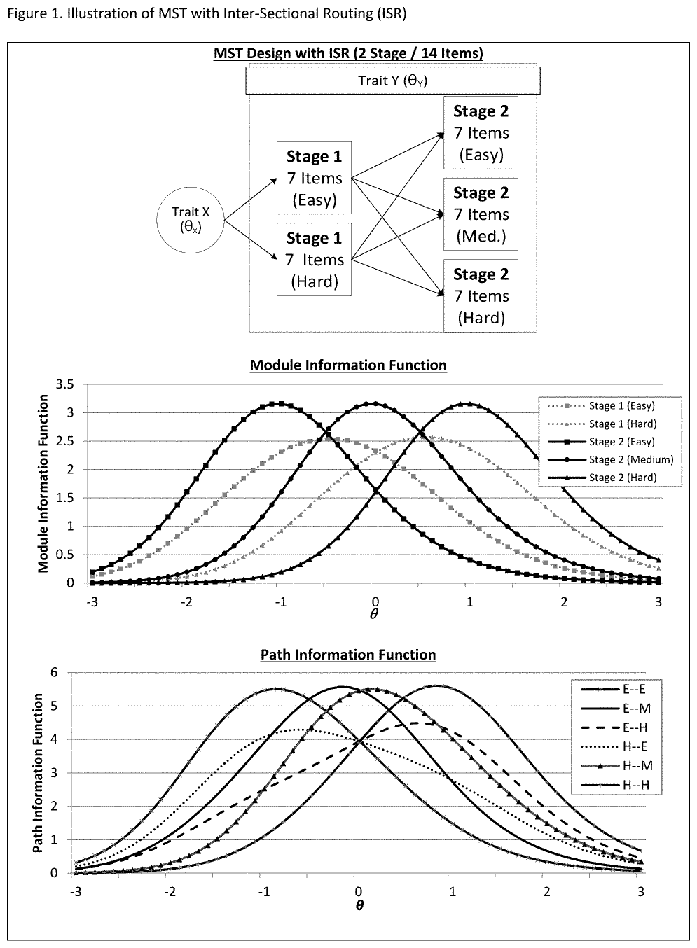

Test programs that measure cognitive skills commonly include several test sections that measure different skills and traits such as quantitative and verbal skills. More often than not, those cognitive skills and traits are closely related, so one usually finds moderate to high correlation among the test section scores reflecting each trait. For example, it is typical to observe a correlational coefficient of 0.50 to 0.70 for math and verbal section scores in many educational test programs. Thus, if one has information about a test taker's score for one trait and about the relationship between the traits, one can predict his or her score for another trait using predictive modeling methods like regression. In MST practice, therefore, if one knows a test taker's score from one section, it would be interesting to see whether it makes any meaningful difference to start the following section not with a routing stage but, instead, with adaptive routing based on the predicted section score. This approach hereafter will be referred to as Inter-Sectional Routing (ISR), and is illustrated in FIG. 1 (uppermost diagram).

The basic logic behind ISR for MST in some ways is equivalent to multidimensional adaptive testing (MAT) for item-level CAT. In MAT (with Bayesian-based θ estimators), unless there is zero correlation among measured traits, a known covariance matrix can be used as a prior for estimating θ on one dimension based on another dimension even when no such item measuring the dimension of θ being estimated was administered. There are several key differences, however, between MST with ISR and MAT. First, MAT involves the use of multidimensional item response theory (IRT) models, whereas, in MST with ISR, the unidimensional structure for each test section is retained. This is a key practical advantage of ISR—it can be implemented easily for test programs using existing items/banks/pools/modules that are already based on unidimensional IRT models with little modification needed. More important, in MAT, the adaptive selection and the θ estimation (both interim and final) are accomplished using a multidimensional IRT framework. Previous studies have found that MAT tends to result in considerable estimation bias especially when tests were short (e.g., 10 and 30 items) and/or were based on Bayesian procedure, where a prior density function played critical roles (van der Linden, 1999). In MST with ISR, on the other hand, the collateral information from the previous test section is used only for routing at the first stage of the following section and is not used for estimating interim and final θ for individual test takers. The complete separation of θ estimation for each section is critically important in actual applications, especially in high-stakes testing. To allow a prior density function and trait score from another dimension to have such a huge impact or influence on a different dimension's θ estimate for each individual, as in MAT, is often not justifiable in terms of test fairness. Whether MST with ISR really is free of estimation bias is something to be investigated later in this study.

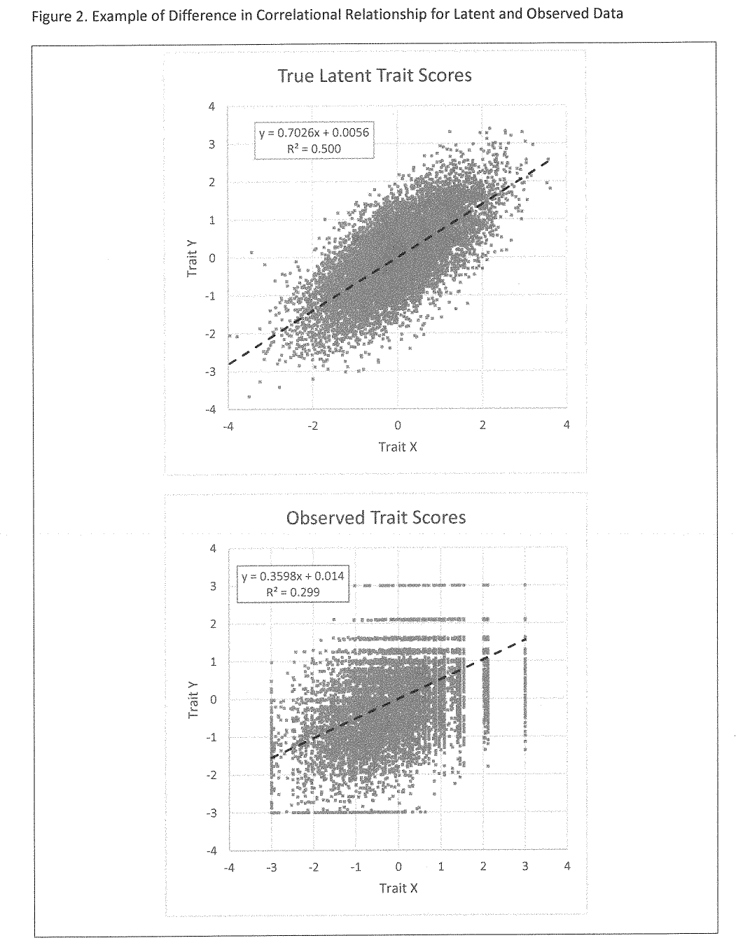

The actual implementation of MST with ISR is not as straightforward as would be suggested by simply applying a regression model to predict an initial routing score based on a score from the previous section. In practice, one typically has well-established knowledge about the relationship between trait scores from different test sections based on long-term data observation of existing test forms and programs. A regression model based on such data, however, does not necessarily present an accurate reflection of the actual relationship of MST section scores that is to be applied with ISR, especially when test-length is very short. For example, if the known latent trait score distributions for Traits X and Y follow a multivariate normal with the latent correlation of 0.7, the regression model to predict y on x would be y=0.7026x+0.0056 with R²=0.500 (FIG. 2, upper). If, however, one observes the actual score distribution of Traits X and Y with short-length test forms (14 items for each section), the regression model to predict y on x would differ: y=0.3598x+0.014 with R²=0.299 (lower section of FIG. 2). The relationship between Traits X and Y in latent scales is seldom retained with observed scores because: (1) standard errors of measurement with the observed scores are often quite large especially when the test is short, (2) the number of observable data points from each test section is very limited, and as a result, the shape of an observed score histogram may differ substantially from the latent trait scores on a continuous scale, and (3) θ scales are truncated, which necessarily happens with the maximum likelihood (ML) method for θ estimation. To address these issues when applying ISR in an existing or newly developed MST-based exam, the following framework is suggested:
1. Identify (almost) true latent distributions and the relationship of two traits (X and Y) based on large sample administrations of longer versions of the test and/or several different test forms.
2. Conduct a simulation study for the actual test section (Section X) for Trait X, using the true latent distribution identified from Step 1.
3. Conduct a simulation study for the actual test section (Section Y) for Trait Y, using the true latent distribution identified from Step 1. In the first stage of Section Y, the routing is based on the true y value.
4. Compute a regression model, θ_{y}⁰=f(\hat{θ}x), for predicting θ_{y}⁰ on \hat{θ}ₓ, based on the observed data from Steps 2 and 3.
5. Use the regression model (θ_{y}⁰=f(\hat{θ}ₓ)) from Step 4 to rout in the first stage of Section Y for operational administration of the test.
   Because different test forms will yield different observed data in Steps 2 and 3 when there are multiple test panels, this framework should be implemented for each MST test panel and the regression model for ISR should be integrated into each panel. Also, it is advised to have a large enough sample (for example, one thousand or more) in Steps 2 and 3 to result in a stable regression model in Step 4.

The framework described herein presents a series of simulation studies designed to evaluate the behavior and effectiveness of applying ISR in MST with a short-test length using the suggested framework. Studies 1 and 2 focus on evaluating the performance and behavior of MST with ISR when there are two and three modules to rout to, respectively, and Study 3 looks at ISR cases that use other regression models including polynomial regression and multiple regression. An actual implementation of the proposed framework for developing short-length MST with ISR is also introduced, followed by a comprehensive discussion of the implications of the MST with ISR with other MST approaches and designs.

### Study 1: MST with 2-3 Structure

### MST Design and Data

The results of Study 1 show how the MST design (illustrated in FIG. 1) was developed and implemented. Stages 1 and 2 each included seven items, each one based on the 3-parameter logistic (3PL) model with a-parameter value of 1 and c-parameter value of 0.2. The items differed only in the b-parameter values. The shape of the module information function was controlled to be the same across modules within each stage (middle of FIG. 1) to minimize the possible impact of extraneous factors on the study. For the initial routing with ISR when the first stage began, the θ estimate from the previous section—measuring trait X (\hat{θ}ₓ)—was used to compute the ISR score (θ_{y}⁰) based on the regression model (f(\hat{θ}ₓ)), as explained in the proposed ISR framework. The previous test section measuring trait X was designed as a fixed form consisting of 14 items whose b-parameter distribution was closely matched with the true θₓ distribution, which was standard normal. Once the first stage with the ISR-based module was finished, the routing for the second stage was performed as a typical MST based only on \hat{θ}_{y} from the seven items of the first stage. For ISR at the first stage and routing at the second stage, the module to be administered was selected based on the module information function given θ_{y}⁰ and \hat{θ}_{y}, respectively.

For simulation, the study generated 100,000 simulees to have two latent trait scores, θₓ and θ_{y} for traits X and Y, respectively. The latent traits were drawn randomly from a multivariate normal distribution, and each trait followed a standard normal distribution. The three studied conditions had different correlations between traits X and Y; 0.3, 0.5, and 0.7, which hereafter will be referred to as ISR Conditions 1, 2, and 3, respectively. Two other conditions were studied to provide a baseline for comparison. The first baseline condition was a typical MST exam with a first stage as a routing stage. Among the 14 items in the two modules with ISR conditions, seven items were selected to form a module for the routing stage, and the b-parameter distribution of the seven items were matched with the true θ_{y} distribution. Another baseline condition involved routing for the first stage (with multiple modules) based on the individual's true latent score (θ_{y}). This condition, referred to as ISR Condition 0, served as a baseline to evaluate the theoretical upper bound of effectiveness of the ISR approach. The MST simulation was conducted using an MSTGen software package (Han, 2013).

### Results and Discussion

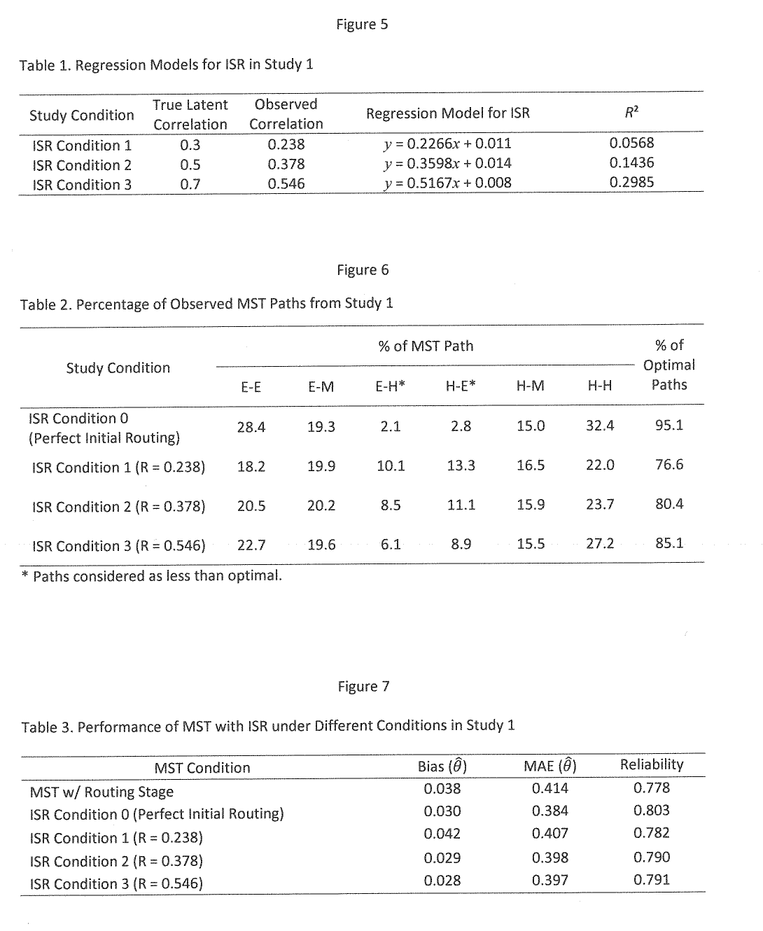

The actual observed correlation coefficients of \hat{θ}ₓ and \hat{θ}_{y} under the studied conditions are reported in Table 1 shown in FIG. 5. As noted earlier, the observed correlation differed substantially from the true latent correlations, generally lower by about 0.06 to 0.15 across the three ISR conditions. The regression model for computing the ISR routing score (θ_{y}⁰=f(\hat{θ}ₓ)) based on the observed \hat{θ}ₓ for each condition is also reported in Table 1 shown in FIG. 5.

Table 2 shown in FIG. 6 displays the percentage of observed MST paths under each condition. Under ISR Condition 0, which was the baseline for the expected upper bound of ISR with perfect routing at the first stage, 95.1% of cases had optimal paths. The remaining 4.9% of cases showed less than optimal paths, where the choice of module for the first stage was not adjacent in module difficulty to the choice of module at the second stage. This indicated the impact of the measurement error from the seven first-stage items on the routing for the second stage even when the routing at the first stage was perfect. Using this as a baseline made the interpretation of the results from ISR Conditions 1, 2, and 3 more meaningful and practical. As the observed correlation of \hat{θ}ₓ and \hat{θ}_{y} increased from 0.238 (ISR Condition 1), to 0.378 (ISR Condition 2), to 0.546 (ISR Condition 3), the percentage of optimal MST paths also increased from 76.6% to 80.4% to 85.1%, respectively.

The measurement efficiency and score estimation accuracy across the studied conditions were evaluated using mean absolute errors (MAE) and bias statistics for θ estimation as well as the score reliability coefficient. As shown in Table 3 shown in FIG. 7, the MAE tended to decrease among the ISR conditions as the observed correlation increased. In comparison with the MST condition with routing stage, all ISR conditions exhibited smaller MAE. The MAE observed under ISR Condition 3, for example, was smaller than that observed for the MST condition with routing stage by about 0.017. Among the ISR conditions, the difference in MAE between Conditions 2 and 3 was only about 0.001, whereas the difference between Conditions 1 and 2 was about 0.009. This suggests a corresponding growth in improvement in measurement efficiency of MST with the ISR as the correlational relationship between section scores increases. Once the correlation becomes larger than that achieved with Condition 2 (R=0.378), however, further increases in correlation between section scores will not necessarily lead to a meaningful increase in ISR measurement efficiency. ISR Condition 0, which essentially represented unrealistic, fictional cases with zero measurement error with \hat{θ}ₓ and perfect ISR score prediction (i.e., R²=1, and, thus, θ_{y}⁰=θ_{y}), resulted in an MAE of 0.384. Given that and the difference in MAE between ISR Conditions 2 and 3 (which was as small as 0.001), further improvement of MAE with the ISR approach generally would be possible only by having a smaller estimation error for x. In short-length test programs, however, there is little meaningful room for improving the estimation error for \hat{θ}ₓ. Therefore, the magnitude of the positive effect observed with ISR Conditions 2 and 3 in MAE compared with the typical MST condition with routing stage might be the closest result that could be achieved in an actual setting of MST with a short test length. A reduction of MAE by about 0.017 with the ISR approach might seem too small to be meaningful, but such a reduction would be the equivalent of adding about one item (with item difficulty optimally matching with \hat{θ}_{y}) or more (with less than optimal matching). For a short-length test that includes 14 items per section, for example, this could mean a greater than 10% reduction in section length. Given the same test length (14 items) across the studied conditions, the positive effect of the ISR method on score reliability was apparent as the correlation between section scores increased (Table 3 shown in FIG. 7).

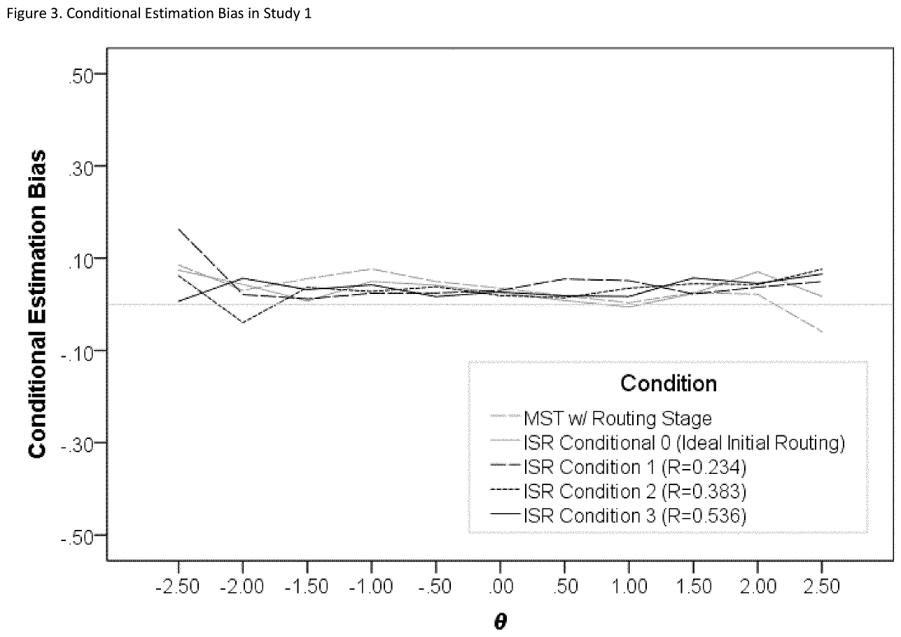

In terms of estimation bias, all studied conditions showed minimal bias (≤0.042), as shown in Table 3 shown in FIG. 7. The conditional estimation bias patterns in FIG. 3 showed no meaningful differences among the studied conditions for most areas of θ. The overall results suggest that use of the ISR approach did not introduce systematic estimation errors.

### Study 2: MST with 3-4 Structure

In Study 1, the first stage of Section Y had only two modules and a routing cut score about zero. The intercept of the regression models to predict ISR scores (θ_{y}⁰) was also near zero because the simulees were drawn from multivariate distributions with a mean of zero. In that scenario, the difference in the slope of the regression models under the ISR conditions with different correlations might not play a critical role in ISR. Study 2 was conducted to evaluate the performance of MST with ISR when there were more than two modules in the first stage of Section Y.

### MST Design and Data

Study 2 involved the development of an MST with ISR design with a 3-4 structure. Like Study 1, all items in the test modules had an a-parameter value of 1 and c-parameter value of 0.2, differing only in b-parameter value. The first stage of Section Y included three modules that had different peak locations for the module information function (MIF) but the same shapes. The routing cut score between Stage 1 Easy and Stage 1 Medium difficulty modules was about −0.3. It was 0.3 between Stage 1 Medium and Stage 1 Hard modules. The second stage involved four modules, again with the same shape but differing only in the location of MIF peak. All other study conditions remained the same as in Study 1.

### Results and Discussion

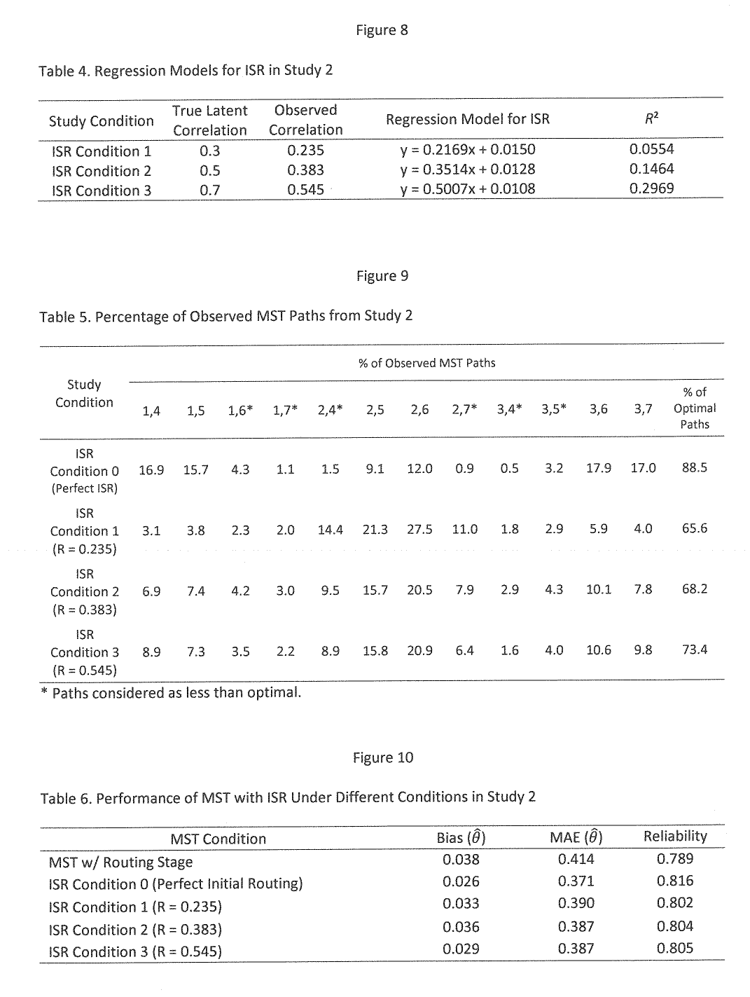

Although the true latent scores, θₓ and θ_{y}, in Study 2 were the same as those seen in Study 1, the observed correlation between \hat{θ}ₓ and \hat{θ}_{y} in Study 2 (Table 4 shown in FIG. 8) was slightly different. This result was due mainly to a change in the MST design of Section Y from the 2-3 structure to 3-4 structure, which thus changed the outcome of Step 3 of the ISR framework. Consequently, the regression models for ISR in Study 2 (Table 4 shown in FIG. 8) all differed slightly as well from ones observed in Study 1 (Table 1 shown in FIG. 5).

The percentage of simulees routed to optimal paths in Study 2 (Table 5 shown in FIG. 9) was smaller than that observed in Study 1 (Table 2 shown in FIG. 6), because of the expanded number of paths in the 3-4 MST structure. Across the ISR Conditions 1, 2, and 3, the higher the observed correlation coefficient between \hat{θ}ₓ and \hat{θ}_{y}, the larger the percentage of simulees who achieved with optimal paths.

The MAE observed in Study 2 generally were smaller than the ones observed from Study 1 across all ISR Conditions by 0.010 to 0.017 (Table 6 shown in FIG. 10). Overall, the results of Study 2 suggest that the effectiveness of MST with ISR can be maintained or further improved when there are more than two modules in the first stage.

Study 3: ISR Scenarios with Other Regression Models

In Studies 1 and 2, simple linear regression models were used to compute the ISR scores (θ_{y}⁰) for routing at the first stage of Section Y. Two additional regression models also may be considered for this purpose, namely polynomial regression and multiple regression.

ISR with Polynomial Regression

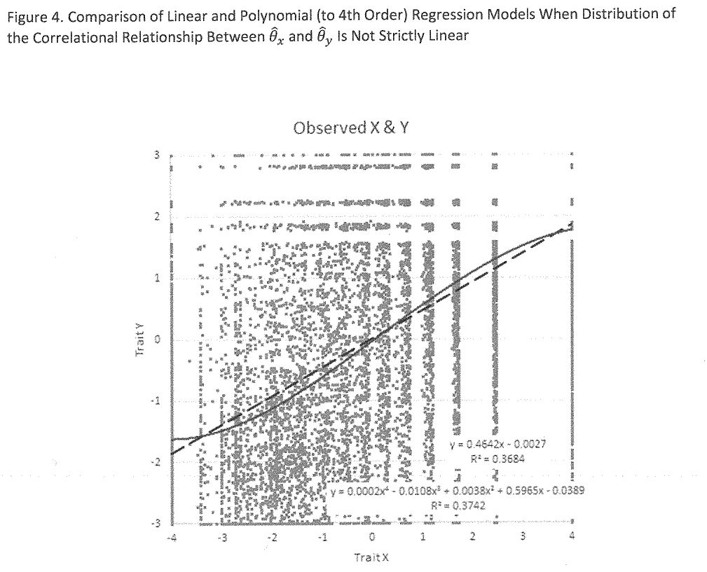

In real-world applications, the correlational relationship between \hat{θ}ₓ and \hat{θ}_{y} often is not strictly linear even when an obvious and strong correlational relationship exists between them. This occurs especially when the distributions of \hat{θ}ₓ and \hat{θ}_{y} differ in shape. In such situations, a polynomial regression model might offer a better fit with higher R² than a typical linear regression model. Such a scenario was investigated and is depicted in FIG. 4. It shows a typical linear regression model for ISR (θ_{y}⁰=0.4642\hat{θ}ₓ−0.0027) which resulted in R² of 0.368, while a polynomial model (θ_{y}⁰=0.0002(\hat{θ}ₓ)⁴−0.0108(\hat{θ}ₓ)³+0.0038(\hat{θ}ₓ)²+0.59656\hat{θ}ₓ−0.0389) resulted in R² of 0.374. When the ISR was applied with the polynomial model and compared with another ISR condition using the linear model (with all other study conditions remaining the same as Study 2), the percentage of optimal paths showed no real difference between them: They both were 69%. The MAE observed under the ISR condition with the polynomial regression model was slightly larger (0.425) compared with the condition with a simple linear regression (0.414). The result suggests that use of polynomial regression over a simple linear regression for ISR does not necessarily improve the measurement error even if polynomial models often show better data-model fit.

A multiple regression approach also could be considered for MST with ISR implementations. Many test programs have more than two sections measuring different traits. For example, one could consider ISR for a test program with three test sections measuring traits X, Y, and Z, which, after sections measuring X and Y are finished, uses a multiple regression predicting \hat{θ}_{z} based on both \hat{θ}ₓ and \hat{θ}_{y}. To investigate an ISR case with a multiple regression method, an additional study was conducted using the ISR Condition 3 of Study 2 as a baseline. For this, Section Z was added, following the exact same design of Section Y in Study 2. The ISR condition with a multiple regression model (θ_{z}⁰=f(\hat{θ}ₓ, \hat{θ}_{y})) resulted in substantially higher R² (0.3985) than the ISR case with a simple regression model in Study 2 (R²=2969). It also increased the percentage of optimal paths in Section Z to 75.2%, which was moderately higher than what was observed with an ISR condition with a simple regression (73.4%). As a result, the MAE observed with the ISR with multiple regression method turned out to be meaningfully smaller (0.385) than the one observed with the ISR condition with a simple regression model (0.387). These results suggest that an ISR using a multiple regression model can be viewed as a reasonable approach for test programs with more than two sections.

### IV. Real-World Implementation of MST with ISR

The Graduate Management Admission Council® (GMAC®) developed an Executive Assessment (EA) to provide Executive MBA schools and programs with a new tool for admissions decisions. The EA exam has three test sections, each of which measures Integrated Reasoning (IR), Verbal Reasoning (VR), and Quantitative Reasoning (QR) skills, respectively. Each section is separately timed to be up to 30 minutes and consists of two stages. The average correlation between observed IR scores and VR scores is about 0.55, and about 0.40 between observed IR scores and QR scores across all panels.

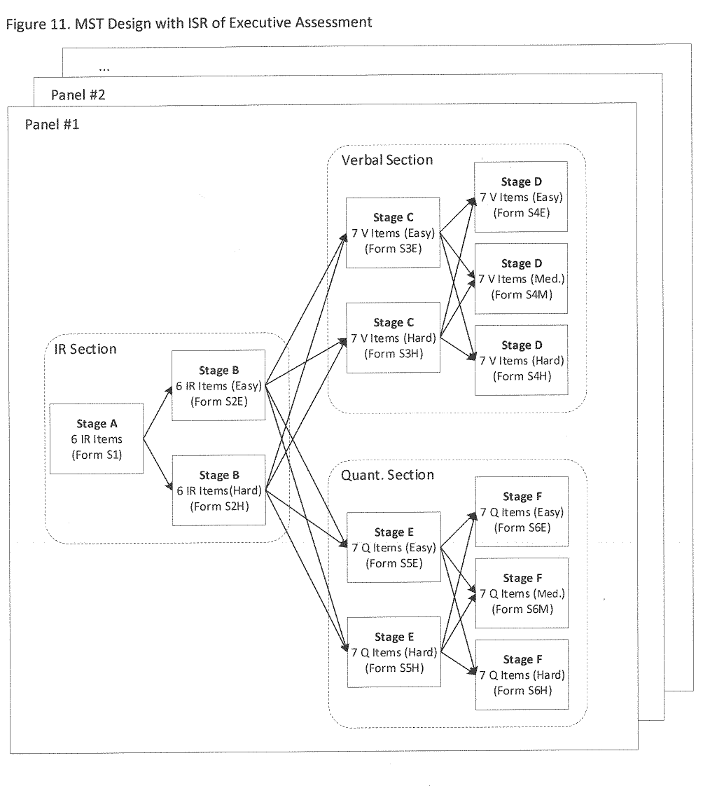

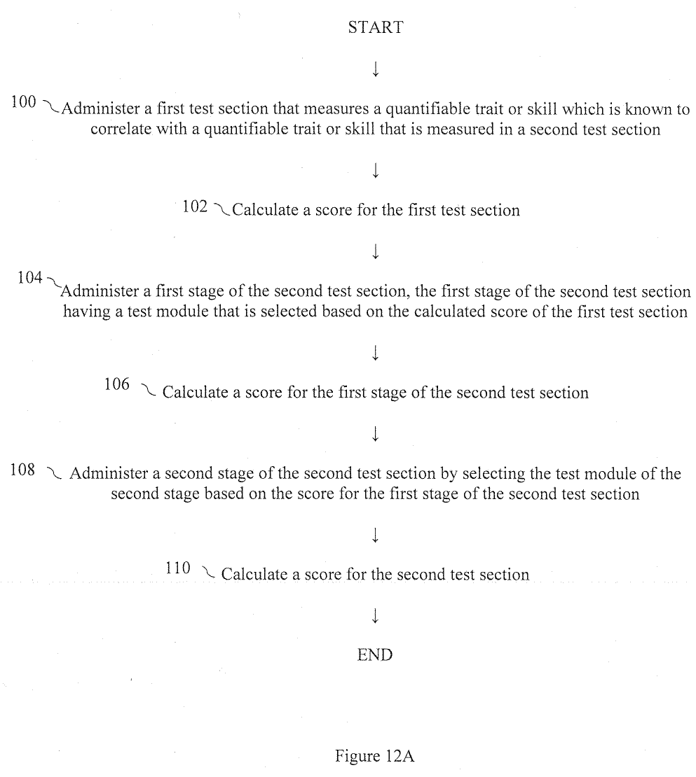

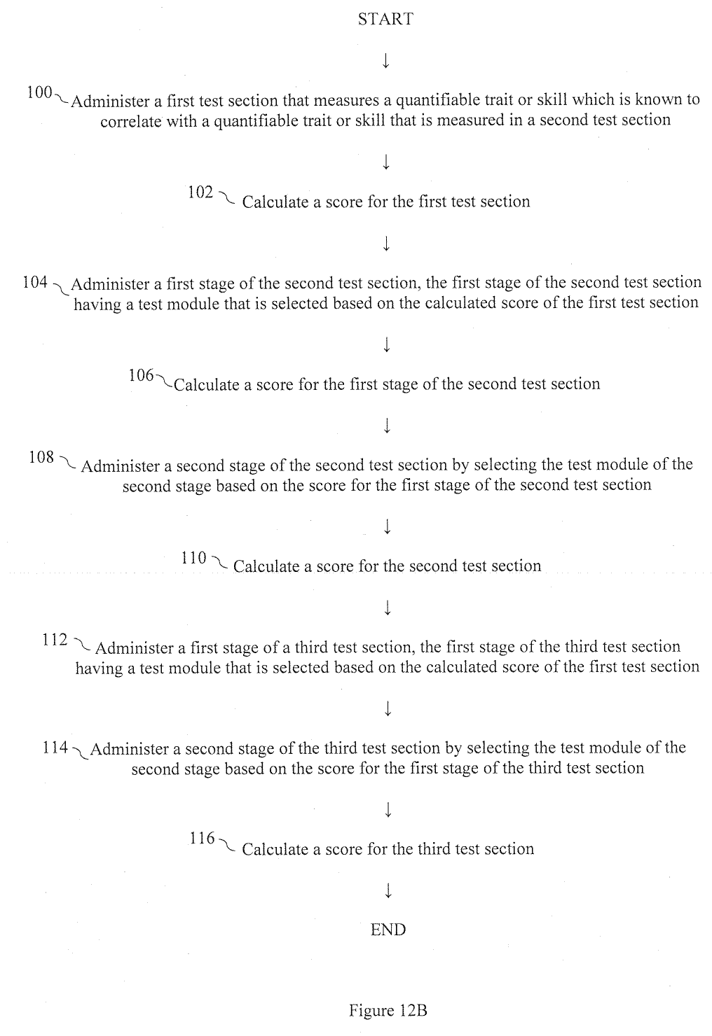

FIG. 11 shows the MST Design with ISR for the EA.

In actual administrations of EA with ISR, the average percentage of the test administered with optimal routing paths was about 86% for the VR section and 80% for the QR section. IR, VR, and QR section scores, which are linear transformations of IRT θ estimates, show reliability of about 0.77 to 0.80, and the EA Total which is a sum of IR, VR, and QR section scores shows reliability of about 0.87, which is quite high for a composite score of multiple traits given the short test length (40 items in total). Compared with the experimental version of EA, which had a linear routing stage in each section without ISR, the operational EA with ISR resulted in a significant improvement in EA Total score reliability across all test panels, at least, by 0.04 without lengthening the test or changing the quality of items.

### DISCUSSION AND CONCLUSION

Although the idea of utilizing pre-knowledge (i.e., prior) or collateral information of other trait dimensions for adaptively selecting items and estimating θ has been brought up under MIRT and MAT frameworks, there have been no studies to date that offer any real-world solutions for MST-based test programs. The ISR framework for MST with multiple modules in the first stage was proposed in this study as a means to improve the adaptiveness of MST especially when the test length is very short (<15 items) and the number of stages is small (two or three). This study proposed and evaluated the implementation of an ISR framework by developing different regression models based on observed score distributions from form-specific simulations and using them for inter-sectional routing in the first stage of an MST section. The overall results of the study indicate that when there is a moderate level of observed correlational relationship between section scores (R>0.37, for example), applying ISR can improve the measurement efficiency of MST and help reduce the number of items by about 10% of test length under the studied conditions. The study also confirmed that implementation of ISR did not cause any score estimation bias and helped to further reduce both systematic and nonsystematic estimation errors.

In all MST-based applications (with or without ISR), there is always a possibility of test takers being routed to a suboptimal module due to measurement error. Most such suboptimal routings usually happen for those test takers whose θ locate around the routing cut score. In MST with ISR, the possibility of suboptimal routing in the first stage is expected to be greater than typical MST because of the role of prediction error (from the regression model used in ISR) on top of the measurement error from the linked previous section(s). Therefore, in practice it is very important to mitigate possible negative impacts of such suboptimal routing especially in the first stage of MST with ISR. One of the most effective approaches to accomplish that goal is to design MST modules in a “staggering” manner between stages. The idea of“staggering” modules is similar to the process of staggering bricks when building a wall. When builders stack up bricks to construct a wall, they lay bricks staggered between courses—in other words, one brick sits on top of two bricks in the row below so that the weak spot of brick joints is reinforced by the staggered brick on top. In the example of FIG. 1 (middle), the routing cut score for Stage 1 was at θ_{y}⁰=0, and, as mentioned, most of the suboptimal routings would happen around that due to the combination of measurement and prediction errors. By making one of modules in Stage 2 (the medium difficulty module in FIG. 1) have its peak of information function at the routing cut for the previous stage, however, test takers whose θ_{y} are near 0 would end up having a similar path information function (PIF) regardless of routing in the first stage. For example, compare the PIFs between E-M and H-M in the bottom of FIG. 1 when −0.5<θ_{y}<0.5). This MST design strategy with a staggered module information function is helpful in general with any MST applications when having a consistent conditional standard error of measurement (CSEM) is important goal, but it is especially worth considering for the first two stages in MST with ISR.

Although all simulation studies in this described framework were based on the conventional MST with preassembled modules, the proposed framework for developing ISR-based MST with short test length is fully applicable to the MST approaches with module assembly on-the-fly using CAT item selection methods, module shaping method (Han & Guo, 2013), or shadow test assembler. In MST with modules assembled on-the-fly, the target module difficulty and/or the location of peak module information function for the first stage could be determined using the ISR development framework and regression model (θ_{y}⁰=f(\hat{θ}ₓ)). In addition, in MST with on-the-fly module assembly, it would be possible to control the target not only for the location of peak of module information function or the average item difficulty of a module but also for the overall shape of module information function (Han & Guo, 2013). It would be an interesting topic for future research to develop a systematic approach for ISR-based MST with modules assembled on-the-fly to determine the optimal shape of module information function (not just optimal location of peak) given the expected measurement errors on \hat{θ}ₓ and prediction errors on f(\hat{θ}ₓ).

The conditions studied in this research were extensive, covering different MST designs and different relationship and distributions of θ, as well as different types of regression models for ISR. It should be noted. however, that the findings of this study are not necessarily generalizable to all other MST conditions and designs since there are numerous factors, such as shapes of module information functions and their level of overlap in each stage, for example, that can substantially affect MST performance and behavior. The good news is that, with the proposed ISR framework, test developers and practitioners can easily investigate and evaluate the expected ISR performance and behaviors with specific designs and forms of their own MST-based test programs.

### IV. References

Armstrong, R. D., Jones, D., Koppel, N., & Pashley, P. (2004). Computerized adaptive testing with multiple-form structures. Applied Psychological Measurement, 28, 147-164.
Han, K. T. (2013). MSTGen: Simulated data generator for multistage testing. Applied Psychological Measurement, 37(8), 666-668.
Han, K. T., & Guo, F. (2013). Multistage testing by shaping modules on the fly. GMAC Research Report, RR-13-01.
Jodoin, M. G., Zenisky, A. L., & Hambleton, R. K. (2006). Comparison of the psychometric properties of several computer-based test designs for credentialing exams with multiple purposes. Applied Measurement in Education, 19, 203-220.
Luecht, R. M., Nungester, R. J. (1998). Some practical examples of computer-adaptive sequential testing. Journal of Educational Measurement, 35(3), 229-249.
Thompson, N. A., & Weiss, D. A. (2011). A framework for the development of computerized adaptive tests. Practical Assessment, Research & Evaluation, 16(1). Available online: HyperText Transfer Protocol://pareonline.net/getvn.asp?v=16&n=1.
van der Linden, W. J. (1999). Multidimensional adaptive testing with a minimum error-variance criterion. Journal of Educational and Behavioral Statistics, 24, 398-412.

Preferred embodiments of the present invention may be implemented as methods, of which examples have been provided. The acts performed as part of the methods may be ordered in any suitable way. Accordingly, embodiments may be constructed in which acts are performed in an order different than illustrated, which may include performing some acts simultaneously, even though such acts are shown as being sequentially performed in illustrative embodiments.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention.

What is claimed is:

1. An automated method for administering a test to a test taker using multistage testing, wherein the test includes a plurality of different test sections, each test section measuring a different quantifiable trait or skill, at least some of the test sections including a plurality of stages, each stage having a test module, each test module including a plurality of test items, the method comprising:
(a) administering a first test section to the test taker via a computer interface that electronically communicates with a test administration server, wherein the first test section measures a quantifiable trait or skill which is known to correlate with a quantifiable trait or skill that is measured in a second test section;
(b) calculating a score for the first test section using a scoring engine of the test administration server; and
(c) administering the second test section to the test taker via the computer interface and the test administration server, the second test section measuring a different quantifiable trait or skill than the first test section, the second test section having a plurality of stages, wherein the first stage of the second test section is not a routing stage, the first stage of the second test section having a test module that is selected by the test administration server from eligible test modules designated for use in the first stage of the second test section, the test module selection being based on the calculated score of the first test section.

2. The method of claim 1 wherein the test includes a third test section, and wherein the third test section measures a quantifiable trait or skill which is known to correlate with a quantifiable trait or skill that is measured in the first test section, and wherein the method further comprises:
(d) administering the third test section via the computer interface and the test administration server, the third section measuring a different quantifiable trait or skill than the first test section, the third test section having a plurality of stages, wherein the first stage of the third test section is not a routing stage, the first stage of the third test section having a test module that is selected by the test administration server from eligible test modules designated for use in the first stage of the third test section, the test module selection being based on the calculated score of the first test section.

3. The method of claim 1 wherein the test includes a third test section, and wherein the third test section measures a quantifiable trait or skill which is known to correlate with the quantifiable traits or skills that are measured in the first and second test sections, and wherein the method further comprises:
(d) calculating a score for the second test section using the scoring engine of the test administration server; and
(e) administering the third test section to the test taker via the computer interface and the test administration server, the third section measuring a different quantifiable trait or skill than the first and second test sections, the third test section having a plurality of stages, wherein the first stage of the third test section is not a routing stage, the first stage of the third test section having a test module that is selected by the test administration server from eligible test modules designated for use in the first stage of the third test section, the test module selection being based on calculated scores of the first and second test sections.

4. The method of claim 1 wherein the method further comprises:
(d) calculating a score for the first stage of the second test section using the scoring engine of the test administration server, wherein step (c) further comprises administering the second stage of the second test section by selecting the test module of the second stage by the test administration server from eligible test modules designated for use in the second stage of the second test section based on the score for the first stage of the second test section.

5. The method of claim 1 wherein the quantifiable traits or skills include quantitative skills and verbal skills.

6. The method of claim 1 wherein the plurality of test modules are preassembled.

7. The method of claim 1 wherein the plurality of test modules are assembled on-the-fly.

8. The method of claim 1 wherein the first test section has a plurality of stages, and the first stage is a routing stage.

9. An automated system for administering a test to a test taker using multistage testing, wherein the test includes a plurality of different test sections, each test section measuring a different quantifiable trait or skill, at least some of the test sections including a plurality of stages, each stage having a test module, each test module including a plurality of test items, the automated system including a computer program product comprising a computer readable medium tangibly embodying non-transitory computer-executable program instructions thereon that, when executed, causes a processor of a test administration server to:
(a) administer a first test section to the test taker via a computer interface that electronically communicates with the test administration server, wherein the first test section measures a quantifiable trait or skill which is known to correlate with a quantifiable trait or skill that is measured in a second test section;
(b) calculate a score for the first test section using a scoring engine of the test administration server; and
(c) administer the second test section to the test taker via the computer interface and the test administration server, the second test section measuring a different quantifiable trait or skill than the first test section, the second test section having a plurality of stages, wherein the first stage of the second test section is not a routing stage, the first stage of the second test section having a test module that is selected by the test administration server from eligible test modules designated for use in the first stage of the second test section, the test module selection being based on the calculated score of the first test section.

10. The system of claim 9 wherein the test includes a third test section, and wherein the third test section measures a quantifiable trait or skill which is known to correlate with a quantifiable trait or skill that is measured in the first test section, and wherein the non-transitory computer-executable program instructions, when executed, further cause the processor of the test administration server to:
(d) administer the third test section via the computer interface and the test administration server, the third section measuring a different quantifiable trait or skill than the first test section, the third test section having a plurality of stages, wherein the first stage of the third test section is not a routing stage, the first stage of the third test section having a test module that is selected by the test administration server from eligible test modules designated for use in the first stage of the third test section, the test module selection being based on the calculated score of the first test section.

11. The system of claim 9 wherein the test includes a third test section, and wherein the third test section measures a quantifiable trait or skill which is known to correlate with the quantifiable traits or skills that are measured in the first and second test sections, and wherein the non-transitory computer-executable program instructions, when executed, further cause the processor of the test administration server to:
(d) calculate a score for the second test section using the scoring engine of the test administration server; and
(e) administer the third test section to the test taker via the computer interface and the test administration server, the third section measuring a different quantifiable trait or skill than the first and second test sections, the third test section having a plurality of stages, wherein the first stage of the third test section is not a routing stage, the first stage of the third test section having a test module that is selected by the test administration server from eligible test modules designated for use in the first stage of the third test section, the test module selection being based on calculated scores of the first and second test sections.

12. The system of claim 9 wherein the non-transitory computer-executable program instructions, when executed, further cause the processor of the test administration server to:
(d) calculate a score for the first stage of the second test section using the scoring engine of the test administration server, wherein step (c) further comprises administering the second stage of the second test section by selecting the test module of the second stage by the test administration server from eligible test modules designated for use in the second stage of the second test section based on the score for the first stage of the second test section.

13. The system of claim 9 wherein the quantifiable traits or skills include quantitative skills and verbal skills.

14. The system of claim 9 wherein the plurality of test modules are preassembled.

15. The system of claim 9 wherein the plurality of test modules are assembled on-the-fly.

16. The system of claim 9 wherein the first test section has a plurality of stages, and the first stage is a routing stage.
